(19) United States
(12) Patent Application Publication
(10) Pub. No.: US 2009/0212243 A1
(43) Pub. Date: Aug. 27, 2009

(54) PNEUMATICALLY-OPERATED VALVE FOR NITROUS OXIDE INJECTION SYSTEM

(76) Inventor: Douglas W. Mills, Alachua, FL (US)

Correspondence Address: EDWARD M. LIVINGSTON, PA, 963 TRAIL TERRACE DRIVE, NAPLES, FL, 34103, US

(21) Appl. No.: 12/036,310

(22) Filed: Feb. 25, 2008

(51) Int. Cl. F16K 31/124; F16K 31/122

(52) U.S. Cl. 251/30.01; 251/63.5

(57) ABSTRACT

A nitrous oxide or fuel control valve (26) having flow control of nitrous oxide, fuel or other media from a fluid-delivery aperture (7) into a injection nozzle (22) of an intake manifold of an engine by actuation of an actuation piston (14) that is actuated with gas pressure. It can be structured for low-weight, short-term needs for racing and other sports uses or for heavier long-term needs of engines.

### BACKGROUND OF THE INVENTION

This invention relates to nitrous oxide injection systems, more particularly, to a valve which controls the introduction of nitrous oxide, fuel or any other medium to an injection nozzle prior to injection into a manifold of an internal-combustion engine for enhancing effective pressure of subsequent combustion of the engine for racing and other enhanced-power uses.

Nitrous-oxide injector systems for enhancing power of internal-combustion engines are well known. None, however, are known to provide the introduction and control of nitrous oxide or fuel with an actuator valve operated by a compressed medium applying force to a piston in a cylinder to open the plunger stem of the nitrous oxide or fuel circuit in a manner taught by this invention.

Related but different prior art is known to include the following:

| Patent Number | Inventor | Issue/Publication Date |
|---|---|---|
| U.S. Pat. No. 7,150,443 | Mills | Dec. 19, 2006 |
| U.S. Pat. No. 7,228,872 | Mills | Jun. 12, 2007 |
| U.S. Pat. No. 3,592,357 | Welch | Jul. 13, 1971 |
| U.S. Pat. No. 4,683,843 | Norcia et al. | Aug. 4, 1987 |
| U.S. Pat. No. 4,955,340 | Elliott | Sep. 11, 1990 |
| U.S. Pat. No. 5,063,898 | Elliott | Nov. 12, 1991 |
| U.S. Pat. No. 5,441,234 | White et al. | Aug. 15, 1995 |
| U.S. Pat. No. Re. 35,101 | Kelly | Nov. 28, 1995 |
| U.S. Pat. No. 5,870,996 | DeLuca | Feb. 16, 1999 |
| U.S. Pat. No. 6,073,862 | Touchette et al. | Jun. 13, 2000 |
| U.S. Pat. No. 6,116,225 | Thomas et al. | Sep. 12, 2000 |
| U.S. Pat. No. 6,349,709 | Evert et al. | Feb. 26, 2002 |
| U.S. Pat. No. 6,520,165 B1 | Steele | Feb. 18, 2003 |
| U.S. Pat. No. 6,691,688 B1 | Chestnut | Feb. 17, 2004 |

### SUMMARY OF THE INVENTION

Objects of patentable novelty and utility taught by this invention are to provide a nitrous oxide or fuel control valve which:

requires less space when installed in a nitrous oxide system;

has less weight;

is easy to install;

can be retrofit in existing nitrous oxide systems;

reduces assembly time;

has higher flow rates;

uses less electricity;

can control the flow of a liquid or gaseous fluid;

can be repaired or replaced rapidly, easily and accurately;

can be powered with low-weight and simple power systems; and

can be directly interchangeable with electric solenoid valves of conventional nitrous oxide systems.

This invention accomplishes these and other objectives with a nitrous oxide or fuel control valve having both a flow circuit from a valve with an actuation piston that is actuated with gas pressure from a low-weight actuation-pressure container controlled by a small electrical solenoid valve of low power consumption and low weight and capable of activating one or more nitrous oxide or fuel control valves taught by the present invention. The nitrous oxide is supplied by a low-weight pre-pressured first fluid container while the fuel is supplied by a mechanized pump or an electrical pump.

A plunger stem for the flow circuit is actuated with gas pressure to a pneumatic piston. The oxidizer or fuel are both under pressure for controlled release into the injection nozzle(s) by opening of valves for the separate circuits at the same time.

Prior art nitrous oxide injection systems employ a first separate, heavy and high-current consumption solenoid valve controlling the flow of the oxidizer and a second separate, heavy and high-current solenoid valve for injection of fuel into a mixing nozzle for injection into an intake manifold of an engine. Also, prior art nitrous oxide injection systems utilizing electronic fuel injection to introduce fuel into the engine's induction system and employ a first separate, heavy and high-current consumption solenoid valve to control the flow of the oxidizer to the injection nozzle(s). Accordingly, in proportion to increased engine power achieved by oxidizer injection systems, the combined weight of present systems is approximately two to three times greater and electrical-current consumption can be as much as one-hundred times greater than with this invention.

This invention eliminates the heavy and high current draw solenoid and lifts the plunger stem with a piston. The piston can provide much more lifting power than an electric solenoid, allowing a larger orifice and larger plunger stem to be employed, providing higher flow rates. The larger the orifice and plunger stem, the more area it displaces. The pressure of the medium being controlled can exceed 1,250 psi. This pressure is applied to the total area of the orifice so that the larger the orifice, and therefore the larger the area, the more force required to lift the plunger stem off of the orifice. A piston can provide very high lift force in a compact, lightweight package and not draw any electrical amperage.

Additionally, this invention incorporates an inlet circuit arrangement to provide high flow with reduced flow restrictions. Current nitrous oxide or fuel valves connect the inlet port to the orifice and plunger stem chamber that lies above the inlet port with straight or angled passages. As described hereafter in more detail, this invention places inlet port in alignment with chamber and an oval slot, round hole or other shaped-aperture completes the passage. The plunger stem lifts slightly above the top of the slot, providing unimpeded flow and eliminates a 90 degree (or less) turn (bend) and directs the flow directly into the orifice/plunger stem chamber.

Moreover, this invention may incorporate a built-in distribution block that distributes the nitrous oxide, fuel or other medium to nozzles via tubing.

### BRIEF DESCRIPTION OF DRAWINGS

This invention is described by appended claims in relation to description of a preferred embodiment with reference to the following drawings which are explained briefly as follows:

FIG. 1 is a partially cutaway side view of the control valve of the present;

FIG. 2 is an exterior rear perspective view of the control valve of the present invention;

FIG. 3 is a rear view of the control valve of FIG. 1;

FIG. 4 is an exterior rear perspective view of the control valve of the present invention having a built-in distribution block;

FIG. 5 is a plan view of another plunger stem to actuator piston attachment means; and

FIG. 6 is a plan view of the actuator piston of FIG. 5.

### DESCRIPTION OF PREFERRED EMBODIMENT

A description of the preferred embodiment of this invention follows a list of numbered terms which designate its features with the same numbers on the drawings and in parentheses throughout the description and throughout the patent claims.
1. fluid-supply aperture housing
2. valve housing
3. inlet aperture
4. fluid-supply aperture
5. valve aperture
6. outlet aperture
7. fluid-delivery aperture
8. valve
9. plunger stem
10. injection activator
11. orifice seat
12. expansion-pressure spring
13. cartridge assembly
14. actuator piston
15. actuator cylinder
16. actuation-fluid inlet
17. vent
18. distribution block
19. fluid-supply conveyance
20. fluid container
21. fluid-injection conveyance
22. injection nozzle
23. actuation-fluid conveyance
24. actuation-pressure source
25. actuation on/off valve
26. control valve
27. self-adjustment space
28. distribution port
29. cylinder housing
30. cap screws
31. O-ring
32. isolator bushing
33. actuator piston threads
34. jam nut
35. plunger stem threads
36. attachment means
37. cylinder housing vent slot
38. isolator bushing vent hole

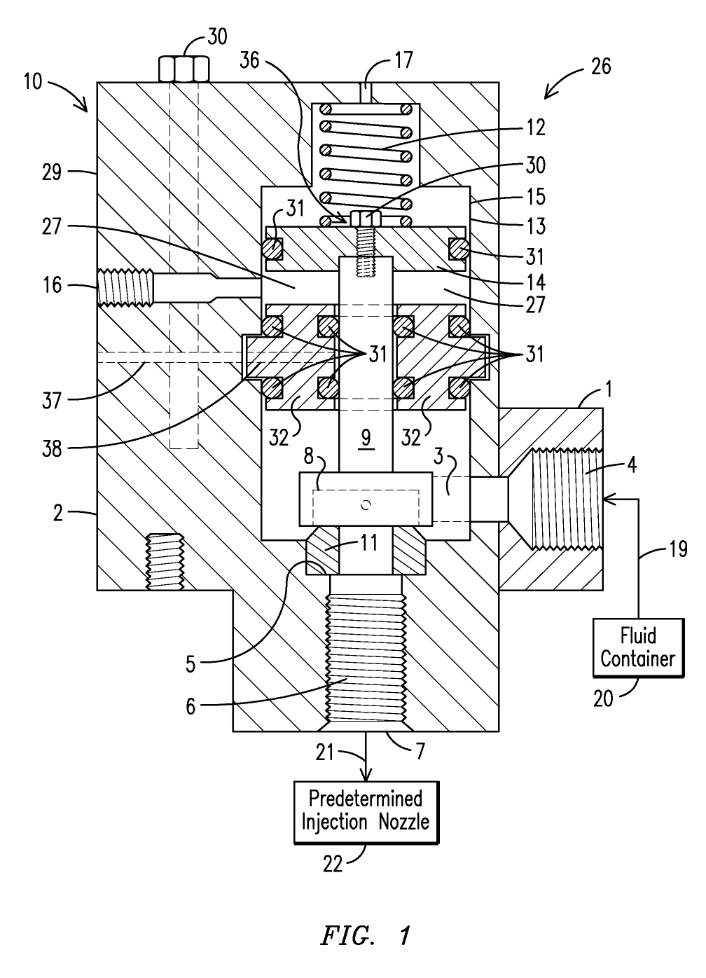

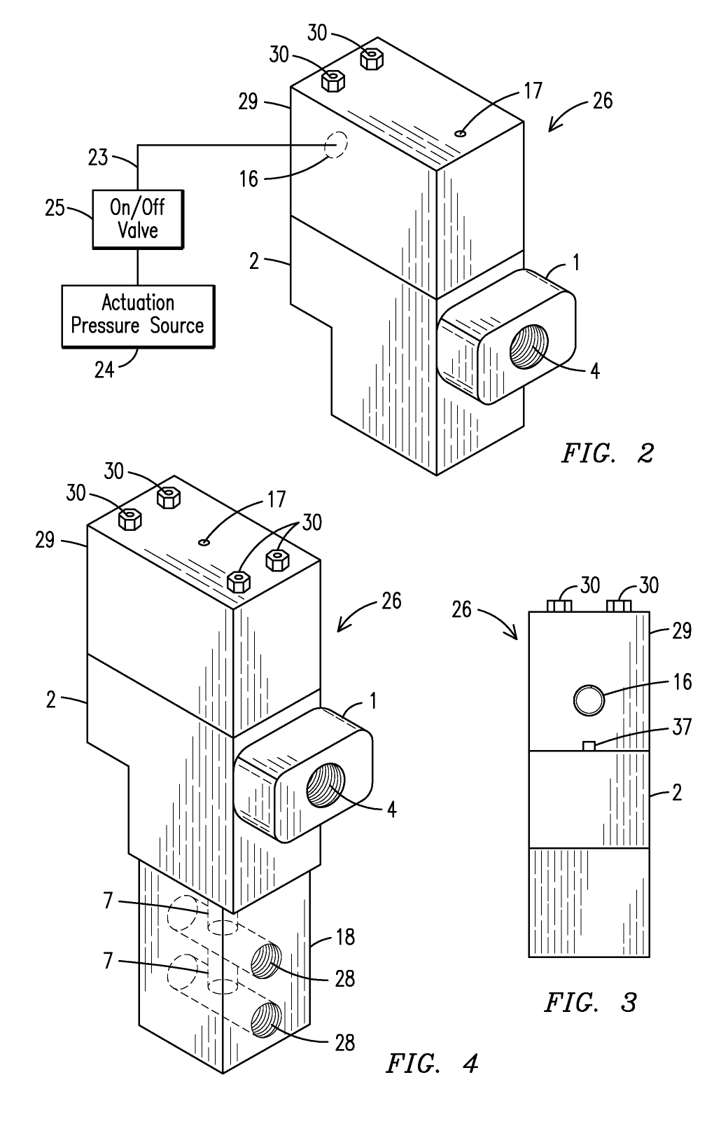

Referring to FIGS. 1, 2 and 3, varying views of the control valve 26 of the present invention are shown. The control valve 26 has a cylinder housing 29 secured to a valve housing 2, preferably in a removable manner via counterbores (now shown). Located on the valve housing 2 is a fluid-supply aperture 1. An inlet aperture 3 is in fluid communication from a fluid-supply aperture 4 in the valve housing 2 to a valve outlet aperture 6 in the valve housing 2. An outlet aperture 6 is in fluid communication from the valve aperture 5 to a fluid-delivery aperture 7 in the valve housing 2.

A valve 8 is positioned on a plunger stem 9. The valve 8 is structured for opening and closing the outlet aperture 6 with the plunger stem 9 predeterminedly.

An actuator piston 14 is directly attached to an end of the plunger stem 9 via an attachment means 36. An injection activator 10 is in communication with the actuator piston 14 with the injection activator 10 being structured for actuating the actuator piston 14 predeterminedly for actuation of the valve 8 with the plunger stem 9.

The valve 8 has a circuit capable of controlling the flow of a gas or liquid, at high or low pressure, or a vacuum. This flow of gas or liquid is stopped (i.e., the valve 8 is OFF when the plunger stem 9, having compliant material on a lower end, such as Viton, Neoprene, Teflon, or similar polymer) is held against a valve outlet aperture 5 by the expansive force of the expansion-pressure spring 12. The flow of gas or liquid is initiated, i.e., the valve 8 is ON, when the valve 8 is lifted off, or above, the outlet aperture 6.

The fluid-supply aperture 4 is structured for receiving a fluid under pressure for directing the fluid to the outlet aperture 6.

The valve 8 can be a poppet valve structured on a valve end of the plunger stem 9 for closing and opening the outlet aperture 6 predeterminedly. A poppet valve is intended to include a class of valves which plug openings to aperture predeterminedly.

A linear axis of the outlet aperture 6 is orthogonal to a linear axis of the fluid-supply aperture 4. A linear axis of the valve 8, the linear axis of the outlet aperture 6 and a linear axis of the plunger stem 9 are collinear.

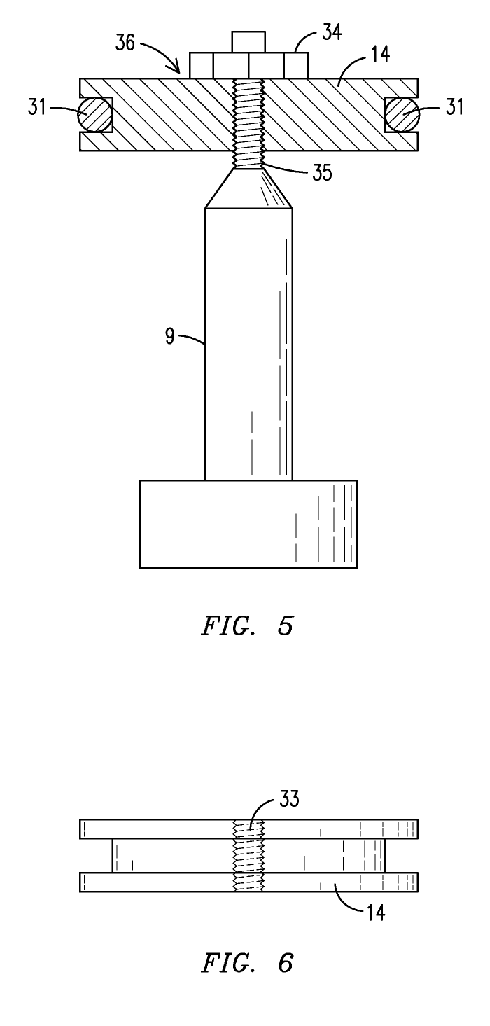

An expansion-pressure spring 12 is connected to the plunger stem 9 and surrounds the attachment means 36, which may be a cap screw 30 as shown in FIG. 1 or a jam nut 34 as shown in FIG. 5, that extends through a top of the actuator piston 14 and is positioned with expansion pressure intermediate an activation end of the plunger stem 9 to maintain a predetermined amount of pressure on the plunger stem 9 for allowing a predetermined inlet pressure of air to open the valve 8 for fluid communication intermediate the inlet aperture 3 and the outlet aperture 6 wherein the expansion-pressure spring 12 is compressed when air actuation pressure lifts the actuator piston 14. When air is released, the expansion-pressure spring 12 allows the valve 8 to close.

The injection activator 10 can include an actuator piston 14 in sliding-seal contact with an inside periphery of an actuator cylinder 15 in the cylinder housing 29. The actuator cylinder 15 has a linear axis collinear to and intermediate the valve-stem guide 1.

A self-adjustment space 27 beneath the actuator piston 14 allows maintains a predetermined amount of force against an orifice seat 11 located beneath the valve 8, even when an insert in the plunger stem 9 wears over time.

The actuation-fluid inlet 16 is in fluid communication with the pressure-actuation floor of the actuator cylinder 15. The pressure-actuation floor of the actuator cylinder 15 is beneath the actuator piston 14 for actuating travel of the cap screw 30 on the actuator piston 14 in the valve-opening direction. The smaller diameter stem of the actuator piston 14 has a sliding seal to contain the actuation fluid. The actuation fluid acts forcefully on both the small diameter and the large diameter of the actuator piston 14 and moves the actuator piston 14 upward in the direction of the most force developed by the larger area of the larger diameter.

O-rings 31 are provided to seal the inlet aperture 3, actuator piston 14 and bottom of the actuator cylinder 15 to isolate the medium being flowed therethrough and control the medium that actuates the actuator piston 14 to open the valve 8.

The internal O-rings 31 of the isolator bushing 32 seal off two dissimilar fluids or mediums at differing pressures, i.e., a lower O-rings 31 seal off N₂O at 1250 psi and upper O-rings 31 seal off CO₂ at 125 psi. In order to eliminate the possibility of the two different mediums (i.e., CO₂ and N₂O) from coming in contact with each other due to leakage of the O-rings 31, an isolator bushing vent hole 38 is provided within the isolator bushing 32 wherein the isolator bushing vent hole 38 is in fluid connection with a cylinder housing vent slot 37 located within the cylinder housing 29, thereby permitting any fluid or medium leakage to be transported to the external surface of the control valve 26.

The fluid-supply conveyance 19 is formed and positioned for fluid communication from a fluid container 20 to the fluid-supply aperture 4.

A fluid-injection conveyance 21 is formed and positioned for fluid communication from the fluid-delivery aperture 7 to a predetermined injection nozzle 22.

An actuation-fluid conveyance 23 is formed and positioned for fluid communication from an actuation-pressure source 24 to the actuator cylinder 15.

An actuation on/off valve 25 is positioned predeterminedly in timing communication intermediate the actuation-pressure source 24 and the actuator cylinder 15.

The actuation-pressure source 24 can include structure for pre-pressured containment of a gas for light-weight and quick-supply needs for racing and other predetermined engine uses.

The actuation on/off valve 25 can include a low-power electrical system for timed release of gas pressure from the actuation-pressure source 24.

The actuation-pressure source 24 can include structure for onboard pressurization of a gas for heavy-duty needs that include transportation, industrial, working and other predetermined engine uses.

Cap screws 30 extend through vertical holes secure the components, i.e., the cylinder housing 29 and valve housing 2, during operation. In addition, at least one vent 17 is preferably located on the cylinder housing 29 to permit excess air to escape.

With reference to FIG. 4, an exterior rear perspective view of the control valve of the present invention having a built-in distribution block is shown. Rather than connecting the fluid-delivery aperture 7 of the control valve 26 to a separate distribution block, a built-in distribution block 18 is provided having at least one distribution port 28 located therein. The distribution ports 28 are in fluid communication with the fluid-delivery aperture 7. In addition, instead of cap screws 30 being utilized to secure the actuator piston 14 to the plunger stem 9, a threaded actuator piston 14 and threaded plunger stem 9 locked together by a jam nut 34 may be utilized (as shown in FIG. 5), as well as other types of attachment means 36.

FIG. 5 shows a plan view of another plunger stem 9 to actuator piston 14 attachment means 36 wherein a jam nut 34 is threadingly secured to plunger stem threads 35 located on the plunger stem 9.

As shown in FIG. 6, actuator piston threads 33 are located within the actuator piston 14 to threadingly secure the plunger stem threads 35 therein.

To reduce assembly time, the O-rings 31 are first assembled around the actuator piston 14 and around and within an isolator bushing 32. The isolator bushing vent hole 38 is aligned with cylinder housing vent slot 37 of the cylinder housing 29 to provide a vent passageway from the center bore of the isolator bushing 32 adjacent to the sealing O-rings 31 to outside of the control valve 26. This feature permits each O-ring 31 to function without the influence of the function of the adjacent O-ring 31. Then, the actuator piston 14, isolator bushing 32 and plunger stem 9 are assembled into a cartridge assembly 13. After an orifice seat 11 is locked into place within the valve housing 2, the cartridge assembly 13 is pushed into the valve housing 2. The expansion-pressure spring 12 is then placed on top of the actuator piston 14 and the cylinder housing 29 is pushed down over the actuator piston 14. Finally, the cap screws 30 are used to join the cylinder housing 29 to the valve housing 2.

A new and useful nitrous oxide injection valve having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A control valve comprising:
a plunger stem in a valve housing;
an inlet aperture in fluid communication from a fluid-supply aperture in the valve housing to a valve aperture in the valve housing;
an outlet aperture in fluid communication from the valve aperture to a fluid-delivery aperture in the valve housing;
a valve on the plunger stem;
the valve being structured for opening and closing the outlet aperture with the plunger stem predeterminedly;
an actuator piston secured to an activation end of the plunger stem via an attachment means;
an expansion-pressure spring proximate the actuator piston for spring-pressing the valve closed and for allowing predetermined inlet pressure air against the actuator piston to open the valve for fluid communication intermediate the inlet aperture and the outlet aperture;
an injection activator in communication with the actuator piston; and
the injection activator being structured for actuating the valve with the plunger stem.

2. The control valve of claim 1 wherein:
the fluid-supply aperture is structured for receiving a fluid under pressure for directing the fluid to the outlet aperture; and
the valve is a poppet valve structured on a valve end of the plunger stem for closing and opening the outlet aperture predeterminedly.

3. The control valve of claim 1 wherein:
a linear axis of the outlet aperture is orthogonal to a linear axis of the fluid-supply aperture;
a linear axis of the valve, the linear axis of the outlet aperture and a linear axis of the plunger stem are collinear; and
the linear axis of the outlet aperture is orthogonal to a linear axis of the fluid-delivery aperture.

4. The control valve of claim 1 wherein:
said attachment means is a cap screw that passes through the actuator piston to attach to the plunger stem; and
an actuation-fluid conveyance is in fluid communication with a pressure-actuation end of the actuator cylinder.

5. The control valve of claim 1 wherein:
said attachment means is a jam nut that passes through the actuator piston to attach to the plunger stem; and
an actuation-fluid conveyance is in fluid communication with a pressure-actuation end of the actuator cylinder.

6. The control valve of claim 4 wherein:
the pressure-actuation end of the actuator piston is above the stem end of the poppet valve for actuating travel of the cap screw in a valve-opening direction.

7. The control valve of claim 1 further comprising:
a distribution block located on said valve housing;
said distribution block in fluid communication with the fluid-delivery aperture; and
at least one distribution port located on said distribution block wherein said at least one distribution port is in fluid communication with said fluid-delivery aperture.

8. A control valve comprising:
a plunger stem in a valve housing;
an inlet aperture in fluid communication from a fluid-supply aperture in the valve housing to a valve aperture in the valve housing;
an outlet aperture in fluid communication from the valve aperture to a fluid-delivery aperture in the valve housing;
a valve on the plunger stem;
the valve being structured for opening and closing the outlet aperture with the plunger stem predeterminedly;
an actuator piston secured to an activation end of the plunger stem via an attachment means;
an expansion-pressure spring proximate the actuator piston for spring-pressing the valve closed and for allowing predetermined inlet pressure air against the actuator piston to open the valve for fluid communication intermediate the inlet aperture and the outlet aperture;
an injection activator in communication with the actuator piston;
the injection activator being structured for actuating the valve with the plunger stem the fluid-supply aperture is structured for receiving the fluid under pressure for directing the fluid to the outlet aperture;
the valve is the poppet valve structured on the valve end of the plunger stem for closing and opening the outlet aperture predeterminedly;
a linear axis of the outlet aperture is orthogonal to the linear axis of the fluid-supply aperture;
a linear axis of the valve, the linear axis of the outlet aperture and the linear axis of the plunger stem are collinear;
a linear axis of the outlet aperture is orthogonal to the linear axis of the fluid-delivery aperture;
the actuator cylinder has the linear axis collinear to and intermediate the plunger stem;
said attachment means is a cap screw that passes through an actuator piston centerline to attach to the plunger stem;
an actuation-fluid conveyance is in fluid communication with the pressure-actuation end of the actuator cylinder; and
the pressure-actuation end of the actuator piston is above the stem end of the poppet valve for actuating travel of the cap screw in the valve-opening direction.

9. The control valve of claim 8 further comprising:
a distribution block located on said valve housing;
said distribution block in fluid communication with the fluid-delivery aperture; and
at least one distribution port located on said distribution block wherein said at least one distribution port is in fluid communication with said fluid-delivery aperture.

10. A control valve comprising:
a plunger stem in a valve housing;
an inlet aperture in fluid communication from a fluid-supply aperture in the valve housing to a valve aperture in the valve housing;
an outlet aperture in fluid communication from the valve aperture to a fluid-delivery aperture in the valve housing;
a valve on the plunger stem;
the valve being structured for opening and closing the outlet aperture with the plunger stem predeterminedly;
an actuator piston secured to an activation end of the plunger stem via an attachment means;
an expansion-pressure spring proximate the actuator piston for spring-pressing the valve closed and for allowing predetermined inlet pressure air against the actuator piston to open the valve for fluid communication intermediate the inlet aperture and the outlet aperture;
an injection activator in communication with the actuator piston;
the injection activator being structured for actuating the valve with the plunger stem the fluid-supply aperture is structured for receiving the fluid under pressure for directing the fluid to the outlet aperture;
the valve is the poppet valve structured on the valve end of the plunger stem for closing and opening the outlet aperture predeterminedly;
a linear axis of the outlet aperture is orthogonal to the linear axis of the fluid-supply aperture;
a linear axis of the valve, the linear axis of the outlet aperture and the linear axis of the plunger stem are collinear;
a linear axis of the outlet aperture is orthogonal to the linear axis of the fluid-delivery aperture;
the actuator cylinder has the linear axis collinear to and intermediate the plunger stem;
said attachment means is a jam nut that passes through an actuator piston centerline to attach to the plunger stem;
an actuation-fluid conveyance is in fluid communication with the pressure-actuation end of the actuator cylinder; and
the pressure-actuation end of the actuator piston is above the stem end of the poppet valve for actuating travel of the jam nut in the valve-opening direction.

11. The control valve of claim 10 further comprising:
a distribution block located on said valve housing;
said distribution block in fluid communication with the fluid-delivery aperture; and
at least one distribution port located on said distribution block wherein said at least one distribution port is in fluid communication with said fluid-delivery aperture.

12. The control valve as in any one of the preceding claims in which:
a fluid-supply conveyance is structured and positioned for fluid communication from a fluid container to the fluid-supply aperture; and
a fluid-injection conveyance is structured and positioned for fluid communication from the fluid-delivery aperture to a predetermined injection nozzle.

13. The control valve of claim 12 wherein:
an actuation-fluid conveyance is structured and positioned for fluid communication from an actuation-pressure source to the actuator cylinder; and
an actuation on/off valve is positioned predeterminedly in fluid communication intermediate the actuation-pressure source and the actuator cylinder.

14. The control valve of claim 13 wherein:
the actuation-pressure source includes structure for pre-pressured containment of a gas for light-weight uses.

15. The control valve of claim 14 wherein:
the actuation on/off valve includes a low-power electrical system for timed release of gas pressure from the actuation-pressure source.

16. The control valve of claim 13 wherein:
the actuation on/off valve includes a low-power electrical system for timed release of gas pressure from the actuation-pressure source.

17. The control valve of claim 13 in which:
the actuation-pressure source includes structure for onboard pressurization of a gas for heavy-duty uses.

18. The control valve of claim 17 in which:
the actuation on/off valve includes a heavy-duty electrical system for long-term timing of release of gas pressure from the actuation-pressure source.

19. The control valve of claim 13 wherein:
the actuation on/off valve includes a heavy-duty electrical system for long-term timing of release of gas pressure from the actuation-pressure source.
